(19) United States
(12) Patent Application Publication
(10) Pub. No.: US 2008/0288126 A1
(43) Pub. Date: Nov. 20, 2008

(54) Method for Controlling Two Actuators of a Vehicle Capable of Being Responsive to a Common Request

(75) Inventors: Lionel Cordesses, Montigny-le-Bretonneux (FR); Mehdi Gati, Antony (FR); Ophelie Thomassin, Rueil-Malmaison (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 12/066,777

(22) PCT Filed: Aug. 31, 2006
(86) PCT No.: PCT/FR2006/050824

§ 371 Date: Jun. 13, 2008

(30) Foreign Application Priority Data
Sep. 13, 2005 (FR) 0509328

(51) Int. Cl. B60W 40/00

(52) U.S. Cl. 701/1

(57) ABSTRACT

A method for controlling multiple actuators of a vehicle capable of being responsive to a common request, at least one of the actuators having a bandwidth and/or a saturation. The method determines for at least one of the actuators a setpoint value integrating an output physical quantity of at least another of the actuators, such that the actuators or at least some of the actuators operate jointly.

The invention relates to the control of actuators aboard a vehicle.

In a vehicle, decoupling between the driver and the various actuators is increasingly frequent. About ten years ago, the first motorized throttles for controlling fuel flowrate made their appearance in the automobile sector, and subsequently there has been an increasing tendency to break the direct links between the driver and the mechanical members. Hybrid motors in particular necessitate this decoupling since an ordinary driver would be incapable of driving a car while managing the engine and electric motor at one and the same time. Likewise, in an electric braking system, the fact that the driver presses on the brake pedal is interpreted as a braking command.

New problems regarding the slaving of the actuators appear within this perspective of decoupling. Since control passes from that of a single actuator to that of several actuators each having their own dynamics and their own operating span (saturation). A telling example of this typical case is the brake of a car which can deliver only negative torque and which has different dynamics from the dynamics of the engine which, additionally, mainly provides positive torque.

The problem amounts to slaving a multivariable system that is saturated at input (bandwidth) and/or at output (see FIG. 1). The very fact of slaving a system with saturations at input is a problem in itself. Responses to this kind of problem exist. But the fact that the system has several inputs renders the problem more difficult to deal with using the “conventional” approaches. The stipulations require that the torque achieved at output be as faithful as possible to the reference given by the driver, while making the best use of the dynamic characteristics of the actuators available.

The solutions which deal with closely related problems are grouped together hereinafter into two categories. The first category comprises scientific articles.

An example of linear control is described in “Sei-Bum Choi and Peter Devlin. Throttle and brake combined control for intelligent vehicle highway systems. SAE Technical Paper Series, pages 53-60, August 1995”. The slaving of the motor is achieved with the aid of a control with sliding modes, the objective being to minimize the inter-vehicle distance as well as the difference in speed between two cars, the final aim being to effect cruise control. The brake for its part is controlled with a feed forward part so as to compensate for the non-linearities of the model (mainly hysteresis) and to offer proportional feedback for the tracking of the driver's command. The switching strategy is based on the principle of using the engine when positive torque is requested, and of using the brake when the engine brake is insufficient to satisfy the braking request. Two thresholds on the opening of the throttle angle are fixed (α₁>α₀), in such a way that, when the throttle opening is less than α₀, the brake is invoked. When the throttle opening becomes greater than α₁, we switch over to the engine.

An optimal control solution is proposed in “Kyongsu Yi, Youngjoo Cho, Sejin Lee, Joonwoong Lee, and Namkyoo Ryoo. A throttle/brake law for vehicle intellingent cruise control. FISITA World Automotive Congress, pages 1-6, June 2000”. The authors present a control strategy based on three layers. In the first layer, the reference acceleration is generated by calculating the optimal acceleration to reach a certain speed of the vehicle and maintain a certain distance between two vehicles that are following one another. This acceleration passes through a saturation so as to avoid the saturation of the two actuators. In the second layer, the acceleration request is apportioned between the actuators depending on whether the acceleration of the vehicle is less than or greater than a certain threshold. The slaving of the powertrain is carried out with a PI, that of the brake is carried out with the aid of a PID plus a feed forward part, the latter part being achieved in the third layer.

In these solutions, the slaving of each of the two members is carried out independently of the other. The control law is consequently fairly simple and inexpensive in calculation time. However, these same solutions present certain drawbacks. The strategy for switching between the two actuators is empirical. The switching thresholds are chosen in an arbitrary manner. The disregarding of the saturations of the actuators in most work may lead to a deterioration in the performance of the closed loop when the actuator reaches the limit of its operating span.

In documents EP-0 798 150, EP-0 896 896 and U.S. Pat. No. 5,054,570, which pertain to a subject closely related to the problem dealt with in our case, the proposed solutions make it possible to regulate the speed of the vehicle as a function of the distance which separates it from another vehicle and the difference in speed between them. Switching between the acceleration and deceleration actuators is done in an abrupt manner when certain thresholds have been crossed. The thresholds are fixed in an arbitrary manner and no criterion is given regarding their choice. The fact of switching from one actuator to another makes it possible to simplify the problem of studying the stability. Each actuator is slaved independently of the other. The control laws remain fairly simple and consequently do not take too much calculation time. The choice of the thresholds is totally arbitrary and no indication is given regarding the criterion which allows them to be chosen. One is limited by the bandwidth of the actuators seeing as they are each used on their side. The abrupt switchings between the actuators may give rise to discontinuities in the torque delivered.

As has been indicated, the invention is aimed at improving the control of two actuators responding to one and the same request.

For this purpose, the invention envisages a method of controlling several actuators of a vehicle that are capable of responding to one and the same request, at least one of the actuators exhibiting a bandwidth and/or a saturation, in which for at least one of the actuators a command taking account of an output quantity of at least one other of the actuators or of the other actuator is determined, so that the actuators or at least some of them act jointly.

The present invention is aimed at responding to the problem of controlling two actuators that, subsequently in the document, we will dub asymmetric (different bandwidths and/or saturations). As will be seen, the approach set forth allows the synthesis of a control law making it possible to apportion the torque request expressed by the driver between the various actuators.

The method according to the invention may furthermore exhibit at least any one of the following characteristics:
for each actuator a command taking account of an output quantity of at least one other of the actuators or of the other actuator is determined;
for at least one of the actuators a command taking account of an output quantity of each of the other actuators or of the other actuator is determined;
for each actuator a command taking account of the output quantity of each of the other actuators or of the other actuator is determined;
the determination is implemented by consulting a mapping;
at least one of the following data is used as input data to the mapping:
the output quantity of one at least of the actuators; and
the sum of the output quantities of the actuators.
an integer i is determined such that:

Mᵢ[T₁T₂ . . . Tᵢₙ]≦mᵢ

Where: Mᵢ and mᵢ are predetermined matrices associated with i;

Tₙ is the output quantity of the actuator n; and

Tᵢₙ is a quantity corresponding to the request;
the mapping is generated by means of a constrained optimization algorithm;
the mapping is generated by quadratic multiparametric programming;
the determination is implemented by means of a calculation;
the following are calculated:

$$⌊ \begin{matrix}{u}_{1} ( k ) \\ {u}_{2} ( k ) \\ …\end{matrix} ⌋ = {L}_{i} ⌊ \begin{matrix}{T}_{1} ( k ) \\ {T}_{2} ( k ) \\ … \\ {T}_{i n} ( k )\end{matrix} ⌋ + {l}_{i}$$

where: uₙ(k) is the command associated with the actuator n with k sampling parameter;

Lᵢ and lᵢ are matrices given by mapping; and

Tₙ is the output quantity of the actuator n; and

Tᵢₙ is the quantity corresponding to the request.
the or each output quantity (T₁,T₂) is determined and the determination of the or each command is recommenced by taking account of the or each determined quantity.

The invention also envisages a vehicle comprising:
actuators capable of responding to one and the same request, at least one of the actuators exhibiting a bandwidth and/or a saturation; and
a control member, the control member being designed to determine for at least one of the actuators a command taking account of an output quantity of at least one other of the actuators or of the other actuator so that the actuators or at least some of them act jointly.

Other characteristics and advantages of the invention will appear further in the following description of a preferred embodiment given by way of nonlimiting example with reference to the appended drawings in which:

FIG. 1 is a flowchart illustrating an actuator configuration to which the invention applies;

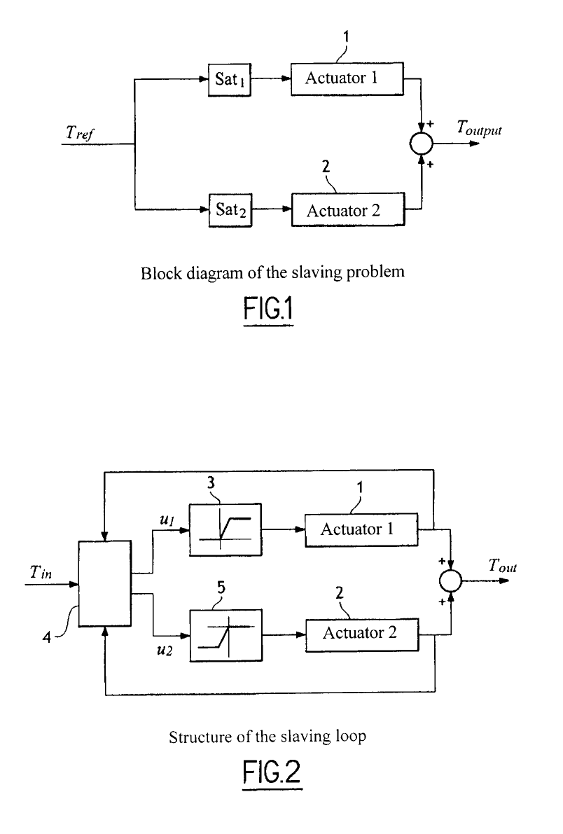

FIG. 2 is a view analogous to FIG. 1 showing the feedback loops occurring within the framework of the invention;

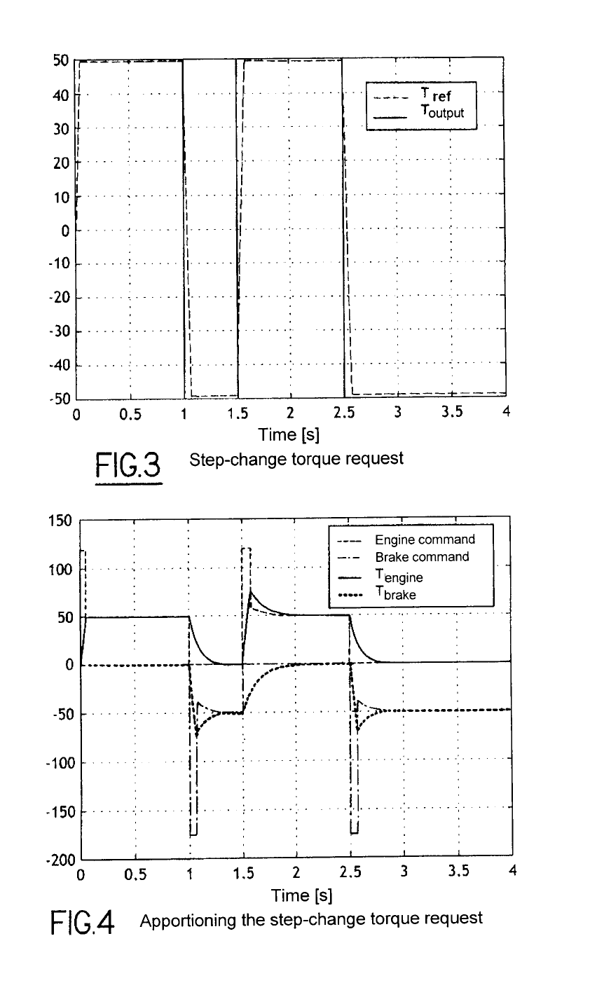

FIG. 3 is a chart illustrating a torque request in the form of step changes and the torque obtained at output during simulation of the operation of the invention;

FIG. 4 illustrates the command signals dispatched to the motor and to the brake as well as the output torques produced by the latter in correspondence with the chart of FIG. 3;

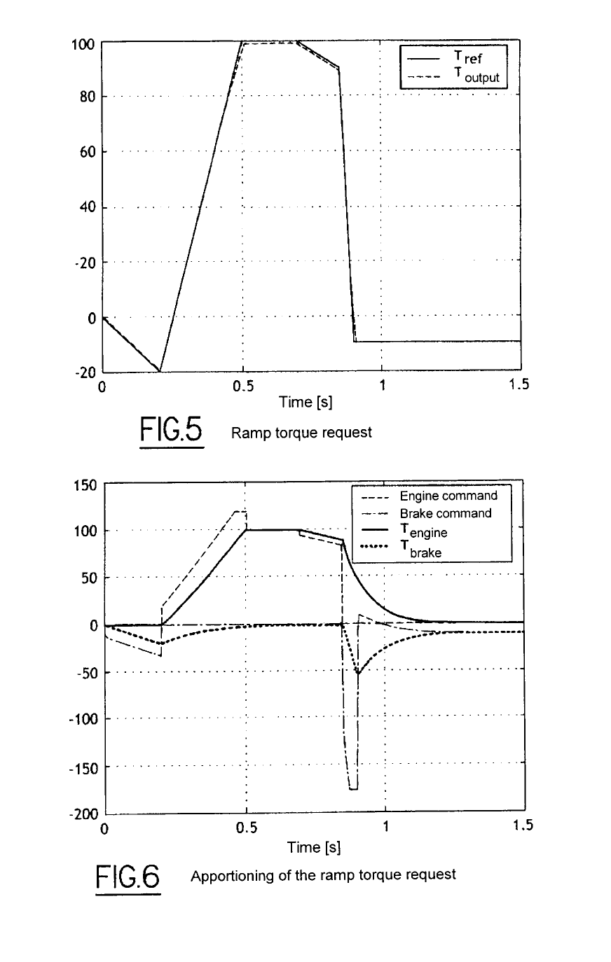

FIGS. 5 and 6 are two charts analogous to FIGS. 3 and 5 corresponding to a ramp torque request; and

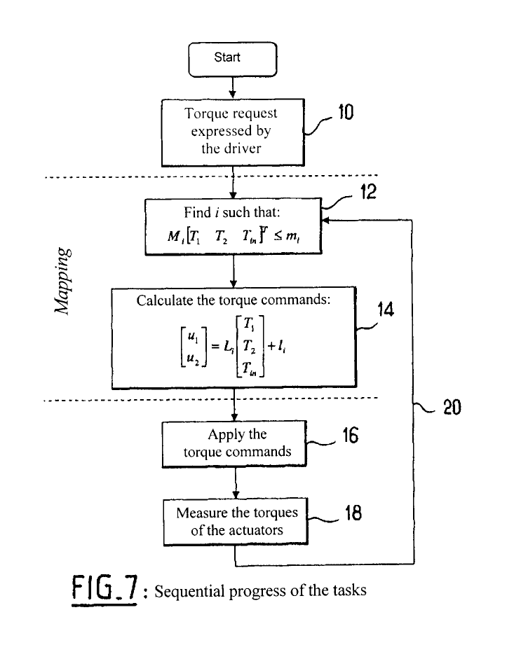

FIG. 7 is a flowchart illustrating the progress of the method according to the invention.

In the present embodiment, a vehicle furnished with two actuators 1 and 2 formed respectively by a motor 1 and a braking device 2 will be considered. The motor may be an internal combustion engine, of petrol or diesel type or else an electric motor, or indeed a hybrid motor.

These two actuators 1,2 are each able to provide a torque so as to satisfy a torque request T_{ref}, formulated by the driver by means of the acceleration pedal or the braking pedal for example. The two actuators are able to act jointly so that the torques provided by the two of them add together so as to provide an output torque Tₒᵤₜₚᵤₜ.

The two actuators each have their own bandwidth and their own operating span as illustrated in blocks 3,5. Thus, as illustrated in FIG. 2, the motor can provide positive torque when a request for positive torque is formulated. When a request for negative torque is formulated, it provides a zero torque. Additionally, the positive torque capable of being provided cannot exceed a maximum value. Conversely, the braking device can provide only negative torque when negative torque is requested, this provision also being limited in absolute value by a maximum value. It provides a zero torque upon a request for positive torque.

As seen, the operating spans of the two actuators therefore have no overlap here. Nevertheless, the invention is applicable to the case where the actuators have operating spans which overlap. It is even particularly advantageous in this case.

Likewise, the number of actuators is limited to 2 here. But it will be possible to apply the invention to vehicles in which the number of actuators that can cooperate so as to respond to a request of the same nature is greater than or equal to 3.

The invention is aimed at carrying out the simultaneous slaving of these two asymmetric actuators. For this purpose, it implements a control algorithm based on calculating the explicit solution of a constrained quadratic optimization problem.

For the implementation of the invention, the vehicle comprises a control member such as a computer or microcontroller 4 able to generate commands u₁ and u₂ so as to control the respective actuators 1 and 2. Moreover, the vehicle comprises sensors informing in return the control member 4 of the output quantities T₁,T₂ actually generated by these actuators.

First of all, the theoretical foundations of the invention will be set forth, then its practical implementation will be presented.

The diagram of the problem that one wishes to deal with is given in FIG. 1. The invention is presented in the context of the control of a motor and a brake. Here it is desired to provide a certain torque with the aid of two actuators. Each actuator delivers torque in a certain span expressed with the aid of the saturations at input. This torque is delivered with a dynamic specific to each actuator (bandwidth and saturation).

The block diagram of the control strategy is presented in FIG. 2. The inputs necessary for carrying out this slaving are also defined.

The prime objective of the control law is to carry out a command tracking that is as perfect as possible between the input Tᵢₙ and the output Tₒᵤₜ of the system. One seeks for this purpose to minimize the error:

e=(Tᵢₙ−Tₒᵤₜ)²

As each of the two actuators considered possesses a dynamic which can be approximated by a first order, it is possible to express the model of the system in the following form:

$$\{ \begin{matrix}{τ}_{1} {T}_{1} + {T}_{1} = {u}_{1} \\ {τ}_{2} {T}_{2} + {T}_{2} = {u}_{2} \\ {u}_{1} ∈ [ {U}_{m}^{1} , {U}_{M}^{1} ] \\ {u}_{2} ∈ [ {U}_{m}^{2} , {U}_{M}^{2} ]\end{matrix} \qquad ( 1 )$$

With
ζᵢ the time constant of the i^{th} actuator;
Tᵢ the torque delivered by the i^{th} actuator;
Uⁱₘ and Uⁱ_{M} respectively the minimum and maximum bounds of the operating span of the i^{th} actuator; and
uᵢ the input (the control) of the i^{th} actuator.

If the sampling period is denoted Tₛ, then the discrete model deduced from the model (1) is given by:

$$\{ \begin{matrix}{T}_{1} ( k + 1 ) = ( 1 - \frac{{T}_{s}}{{τ}_{1}} ) {T}_{1} ( k ) + \frac{{T}_{s}}{{τ}_{1}} {u}_{1} ( k ) \\ {T}_{2} ( k + 1 ) = ( 1 - \frac{{T}_{s}}{{τ}_{2}} ) {T}_{2} ( k ) + \frac{{T}_{s}}{{τ}_{2}} {u}_{2} ( k )\end{matrix} \qquad ( 2 )$$

The output that one wishes to slave is

Tₒᵤₜ(k)=T₁(k)+T₂(k) (3)

The quadratic criterion to be minimized is defined in the following manner

$${J}_{N} = {\sum }_{k = 0}^{N - 1} \{ {u}_{1}^{2} ( k ) + {u}_{2}^{2} ( k ) + {q [ {T}_{i n} ( k ) - {T}_{1} ( k ) - {T}_{2} ( k ) ]}^{2} \} \qquad ( 4 )$$

where q is a weighting parameter so as to penalize one term of the criterion with respect to the other.

The problem can be rewritten in a more compact form:

$${min}_{A ⌊ \begin{matrix}X \\ U\end{matrix} ⌋ \leq B} {U}^{T} RU + {X}^{T} QX \qquad ( 5 )$$

where R>0 and Q≧0 are square matrices of appropriate order. Likewise for the matrices A and B which can be deduced on the basis of the constraints on the inputs and on the torques provided at the output of the actuators 1 and 2. This formulation also comprises the vectors:

U=[u₁(0),u₂(0), . . . , u₁(N−1),u₂(N−1)]′ and

X=[T₁(0),T₂(0), . . . , T₁(N−1),T₂(N−1)]′

According to equation (2), formula (5) can be rewritten

$${min}_{C ⌊ \begin{matrix}x ( o ) \\ U\end{matrix} ⌋ \leq D} {U}^{T} HU + {x ( o )}^{T} FU \qquad ( 5 a )$$

where H, F, C and D are matrices of appropriate dimensions deduced from the matrices A, B, R and Q and equation (2)

and x(0)=[T₁(0), T₂(0)]′

with the change of variable:

Z=U+H⁻¹F×(0) 5(b)

The latter problem (5a) can be rewritten in the form of a quadratic multi-parametric programming problem in the following form:

$$Gz \leq {Sx ( 0 )}^{min} + {W}^{{Z}^{T} HZ} \qquad ( 6 )$$

(See in particular “Alberto Bemporad, Manfred Morari, Vivek Dua, and Efstratios N. Pistikopoulos. The explicit linear quadratic regulator for constrained systems. Automatica, 38:3-20, 2002”).

Solving the latter problem makes it possible to generate a mapping of the admissible operating span of the two actuators considered.

The torque demands u₁ and u₂ are thereafter calculated as being an affine function of the outputs of the two actuators and of the global torque request Tᵢₙ (see FIG. 2):

$$⌊ \begin{matrix}{u}_{1} ( k ) \\ {u}_{2} ( k ) \\ …\end{matrix} ⌋ = {L}_{i} ⌊ \begin{matrix}{T}_{1} ( k ) \\ {T}_{2} ( k ) \\ … \\ {T}_{i n} ( k )\end{matrix} ⌋ + {l}_{i} if {M}_{i} ⌊ \begin{matrix}{T}_{1} ( k ) \\ {T}_{2} ( k ) \\ {T}_{i n} ( k )\end{matrix} ⌋ \leq {m}_{i} i = 1 … Nr \qquad ( 7 )$$

The mapping generated is stored in the computer. As a function of the torque measurements returned by sensors and the torque requested by the driver, the computer gives the commands for each of the two actuators.

The detail of the sequential progress of the operations making it possible to obtain the torque requested aboard the vehicle by the driver has been illustrated in FIG. 10.

In step 10, the control member receives a torque request expressed by the driver and transmitted to the member by way of one or more sensors for example. This is the quantity Tᵢₙ. This value must be taken into account in the following step 12. Values T₁ and T₂ corresponding to the output torque of the two actuators are also taken into account. These are the latest values in memory or reference values used to start the iteration.

In step 12, the control member searches through the mapping held in memory for two matrices Mᵢ and mᵢ satisfying the second part of equation 7 recalled in the box 12 and corresponding to one and the same integer i. This identification is made by using the aforesaid three torque values as input values.

In step 14, the control member thereafter determines the two matrices Lᵢ and lᵢ corresponding to the integer i. Then it calculates the command values u₁ and u₂ with the aid of the first part of equation 7 recalled in the box 14 by means again of the values T₁, T₂ and Tᵢₙ.

Thereafter, in the following step 16, the torque commands thus determined are applied to the two actuators u₁ and u₂

In the following step 18, the output torques T₁, T₂ of these two actuators are actually measured and by virtue of the feedback loop 20, are reused with the new value Tᵢₙ which corresponds to their sum, to carry out the same operations and constitute a slaving.

The output torques of the actuators may be obtained alternatively by means of torque estimators.

Simulations of the operation of the invention are illustrated in FIGS. 3 to 6.

In FIGS. (3) and (5) are illustrated simulations performed with the model described by equation (2), namely the torque that one wishes to provide and the torque actually delivered by the two actuators (the sum of the two torques T₁ and T₂).

FIGS. (4) and (6) show how the torque is apportioned between the various actuators.

FIG. (4) where the request is in the form of step changes shows that, for a request for positive torque of 50 Nm, the mapping expresses a torque request to the motor of 150 Nm (maximum torque) so that the torque provided by the motor climbs as rapidly as possible. Once the latter reaches the value of 50 Nm, the motor torque request returns to 50 Nm. During this time, no torque request is expressed for the brake. The same holds when the torque requested is negative.

In FIG. (6), the torque request is a ramp. When positive torque is requested, the computer systematically invokes the motor, but this time the torque request is not too large with respect to the global demand. On the other hand and this is particularly interesting, when a drop in the total torque is requested and this drop is achievable by the motor, the computer continues to invoke it. If this drop becomes too large, then the computer also invokes negative torque on the part of the brake.

The application of this procedure to the control of two actuators considers the problem as a whole. The control law is calculated on the basis of a model encompassing the dynamics of both of the two actuators with their respective saturations. The mapping generated is the exact solution of a constrained optimization problem. The problem of choosing the thresholds so as to switch from one actuator to another no longer arises. The loop stability problem is also solved by the optimization method.

This procedure exhibits the following advantages:
the problem of calculating the thresholds for switching between the actuators is solved in a mathematical manner,
the slaving law for each actuator is integrated within the mapping,
each of the two actuators works while being aware of the state of the other actuator,
the approach can be applied in the case of several actuators with operating spans which overlap.

The invention comprises the following elements:
a system for measuring or estimating the torques provided by the actuators;
a mapping calculated with a constrained optimization algorithm (Multi-Parametric Programming); and
a computer in which the mapping is stored and which calculates the demands to be dispatched to each actuator.

We have detailed how, when several actuators are available, to apportion a torque request between them. The solution to the problem is obtained by solving a constrained optimization problem.

The approach exhibits very good results but, and this is quite natural, it exhibits certain drawbacks. Particularly, if the actuators have a dynamic of order greater than 1, the mapping will depend on the whole state of the system. Either the measurement of the whole state of the system is available, or it is necessary to synthesize an observer that allows the reconstruction of the state of the system.

The size of the mapping can become very large if one seeks to increase the prediction horizon N during the solution of the optimization problem given in equation (4). A consequence of this is to increase the calculation time.

Finally, this approach can be applied only to actuators which have a linear dynamic and whose saturations remain piecewise linear. It should be noted that it is often feasible to approximate the dynamics of an actuator with linear dynamics.

Of course, numerous modifications may be made to the invention without departing from the scope thereof.

The invention also applies to actuators other than the motor and the brake.

1-13. (canceled)

14: A method of controlling plural actuators of a vehicle that are capable of responding to one and a same request, at least one of the actuators exhibiting a bandwidth and/or a saturation, the method comprising:
determining, for at least one of the actuators, a command taking account of an output quantity of at least one other of the actuators, so that the actuators or at least some of the actuators act jointly.

15: The method as claimed in claim 14, wherein for each actuator a command taking account of an output quantity of the at least one other of the actuators is determined.

16: The method as claimed in claim 14, wherein for the at least one of the actuators a command taking account of an output quantity of each of the other actuators is determined.

17: The method as claimed in claim 14, wherein for each actuator a command taking account of the output quantity of each of the other actuators is determined.

18: The method as claimed in claim 14, wherein the determining is implemented by consulting a mapping.

19: The method as claimed in claim 18, wherein at least one of the following data is used as input data to the mapping:
output quantity of one at least of the actuators; and
the sum of the output quantities of the actuators.

20: The method as claimed in claim 18, wherein an integer i is determined such that:
Mᵢ[T₁T₂ . . . Tᵢₙ]≦mᵢ
in which: Mᵢ and mᵢ are predetermined matrices associated with i;
Tₙ is the output quantity of the actuator n; and
Tᵢₙ is a quantity corresponding to the request.

21: The method as claimed in claim 18, wherein the mapping is generated by a constrained optimization algorithm.

22: The method as claimed in claim 18, wherein the mapping is generated by quadratic multiparametric programming.

23: The method as claimed in claim 14, wherein the determining is implemented by a calculation.

24: The method as claimed in claim 14, wherein the following are calculated:
$$⌊ \begin{matrix}{u}_{1} ( k ) \\ {u}_{2} ( k ) \\ …\end{matrix} ⌋ = {L}_{i} ⌊ \begin{matrix}{T}_{1} ( k ) \\ {T}_{2} ( k ) \\ … \\ {T}_{i n} ( k )\end{matrix} ⌋ + {l}_{i}$$
in which: uₙ(k) is the command associated with the actuator n with k sampling parameter;
Lᵢ and lᵢ are matrices given by mapping;
Tₙ is the output quantity of the actuator n; and
Tᵢₙ is the quantity corresponding to the request.

25: The method as claimed in claim 14, wherein the or each output quantity is determined and the determining of the or each command is recommenced by taking account of the or each determined quantity.

26: A vehicle comprising:
plural actuators capable of responding to one and a same request, at least one of the actuators exhibiting a bandwidth and/or a saturation; and
a control member,
wherein the control member is configured to determine for at least one of the actuators a command taking account of an output quantity of at least one other of the actuators so that the actuators or at least some of the actuators act jointly.
